(19) United States
(12) Patent Application Publication
(10) Pub. No.: US 2015/0200980 A1
(43) Pub. Date: Jul. 16, 2015

(54) Hybrid Client/Server Online Conference Session Management

(71) Applicant: CISCO TECHNOLOGY, INC., SAN JOSE, CA (US)

(72) Inventors: Zhou Guoxin, Suzhou (CN); Qi Shi, Suzhou (CN); Xing Zheng, Suzhou (CN); Hua Ouyang, Suzhou (CN); Zhao Ye, Suzhou (CN)

(73) Assignee: CISCO TECHNOLOGY, INC., SAN JOSE, CA (US)

(21) Appl. No.: 14/153,697

(22) Filed: Jan. 13, 2014

(51) Int. Cl. H04L 29/06; H04L 29/08

(52) U.S. Cl. CPC H04L 65/403; H04L 67/42; H04L 67/28

(57) ABSTRACT

A meeting server facilitates an online conference session between several endpoints. The meeting server receives a request to join the online conference session from a new endpoint. The meeting server identifies at least one endpoint that is already connected to the meeting server that can serve as a proxy endpoint for the new endpoint. This enables the new endpoint to receive data from the online conference session through a connection with the proxy endpoint.

### TECHNICAL FIELD

The present disclosure relates to management of client devices in an online conference session.

### BACKGROUND

Online/web-based meetings allow participants to share documents, audio, video, and other data through connections to a meeting server. In meetings facilitated by an on-premise meeting server, the number of connections to the meeting server is constrained by the resources available to the meeting server. Once a meeting server reaches the maximum number of connections, additional participants are not able to join the meeting.

### BRIEF DESCRIPTION OF THE DRAWINGS

FIG. 1 is a simplified block diagram of an online conference system capable of supporting an online/web-based conference session according to the techniques presented herein.

FIG. 2 is a block diagram of a meeting server device capable of facilitating the online conference session according to the techniques presented herein.

FIG. 3A is a block diagram of an online conference system showing a client device joining the conference session.

FIG. 3B shows an example of a table listing the client devices that are participating in the conference session depicted in the example of FIG. 3A.

FIG. 4A is a block diagram of the online conference system similar to that of FIG. 3A, and showing the meeting server determining the default gateway address for one of the client devices.

FIG. 4B shows an example of a table of the client devices with the same public IP address that are participating in the conference session depicted in the example of FIG. 4A, after one client device's default gateway address is determined according to the techniques presented herein.

FIG. 5A is a block diagram of the online conference system similar to that shown in FIG. 3A, and showing the meeting server determining the default gateway address for another client device.

FIG. 5B is an example of a table of the client devices with the same public IP address that are participating in the conference depicted in FIG. 5A, after a second client device's default gateway address is determined.

FIG. 5C is an example of a table of client devices participating in the conference session and their respective default gateway address.

FIG. 6A is a block diagram of the online conference system, similar to that shown in FIG. 3A, showing the meeting server determining the default gateway address for yet another client device.

FIG. 6B is an example of a table of the client devices with the same public IP address that are participating in the conference session depicted in FIG. 6A, after all of the client devices' default gateway addresses are determined according to the techniques presented herein.

FIG. 6C is an example of a table of client devices participating in the conference session depicted in FIG. 6A, with two client devices having the same default gateway address.

FIG. 7 is a block diagram of an online conference system with a meeting server configured to manage the data shared in the conference session and a control server configured to manage the signaling and control features of the techniques presented herein.

FIG. 8 is a block diagram of the online conference system with a designated proxy client providing the data for all of the other clients on a local network according to the techniques presented herein.

FIG. 9 is a block diagram of the online conference system with a designated proxy client and a backup proxy client on a local network according to the techniques presented herein.

FIG. 10 is a block diagram of the online conference system including a monitor server that determines the capacity of the conference system using the techniques presented herein.

FIG. 11 is a flowchart of an example process of the meeting server adding an additional client device to the conference session according to the techniques presented herein.

FIG. 12 is a flowchart of an example process of a client device joining the conference session according to the techniques presented herein.

### DESCRIPTION OF EXAMPLE EMBODIMENTS

### Overview

A meeting server facilitates an online conference session between several endpoints. The meeting server receives a request to join the online conference session from a new endpoint. The meeting server identifies at least one endpoint that is already connected to the meeting server that can serve as a proxy endpoint for the new endpoint. This enables the new endpoint to receive data from the online conference session through a connection with the proxy endpoint.

### Example Embodiments

The techniques presented herein provide a way for a meeting server with constrained resources to accommodate additional endpoints (e.g., client devices) by connecting to the additional endpoints through an endpoint already connected to the meeting server. The already-connected endpoint is used as a proxy for the meeting server, and relays the data from the conference session between the meeting server and the additional participant's endpoint device. Hereinafter, endpoints may be referred to interchangeably as client devices, clients, and/or participant devices.

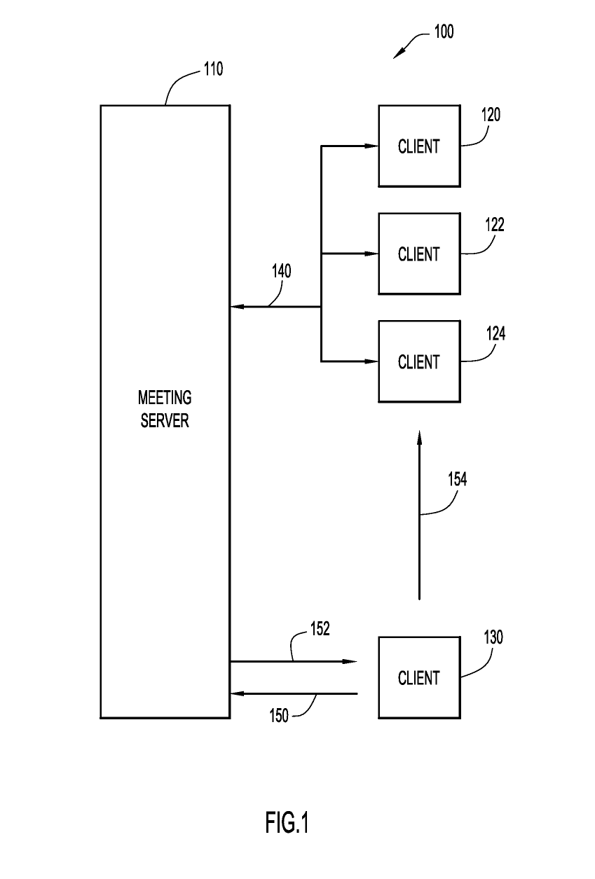

Referring to FIG. 1, an online conference system 100 is shown with meeting server 110 enabling client (endpoint) devices 120, 122, 124, and new client (endpoint) device 130 to share documents and information in an online conference session 140. New client device 130 joins the online conference session by sending message 150 to meeting server 110. If the meeting server 110 does not have the capacity to connect directly to new client 130, it returns message 152 with the address for a client device 124 that has already joined the conference session. New client 130 then joins the conference session by sending message 154 to client 124, and thereafter sending and receiving the conference session data through proxy client 124. Only four client devices are shown in FIG. 1, but any number of client devices may be included in system 100. Client devices 120, 122, 124, and 130 may take a variety of forms, including a desktop computer, laptop computer, mobile/cellular phone, tablet computer, etc. Online conference session 140 may be conducted over any type of one or more networks (e.g., any combination of Internet, intranet, local area network (LAN), wide area network (WAN), wired network, wireless network, etc.) that connects computing devices, e.g., meeting server 110 and client devices 120, 122, 124, and 130. Meeting server 110 may be used, for example, to mediate transactions between the client devices. Server 110 may also perform caching or other time/bandwidth saving techniques. It should be understood that in a web-based conference system, each device may communicate with the server 110 through a browser application having one or more plug-ins that enable web-based meeting, and allow for the transmission of data to the meeting server 110, and the reception of data from the meeting server during a conference/meeting session.

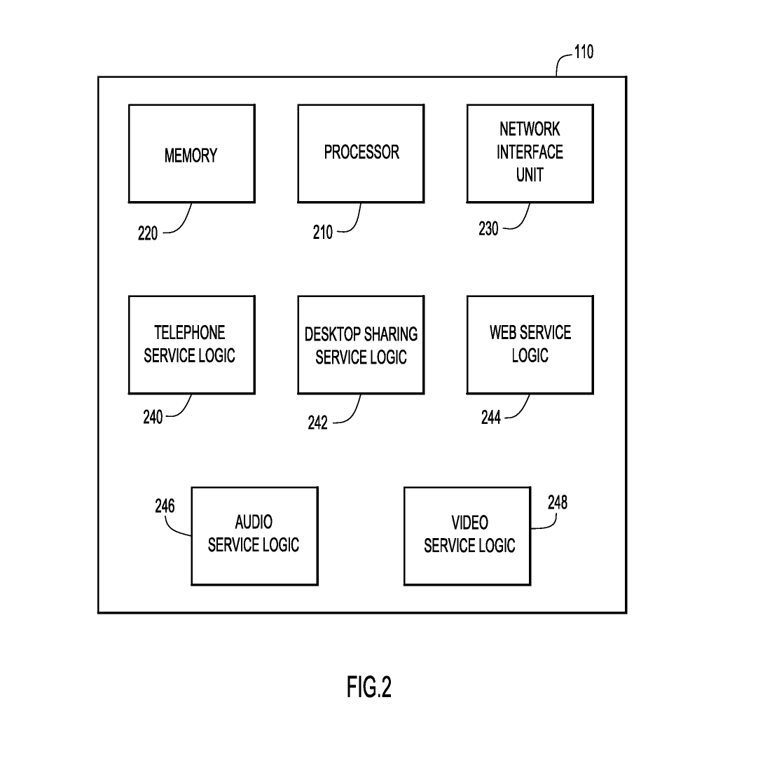

Referring now to FIG. 2, a simplified block diagram of an example meeting server is shown. Meeting server 110 includes a processor 210 to process instructions relevant to a conference/meeting session supported by the system 100, memory 220 to store a variety of data and software instructions (e.g., display data for shared documents, applications, as well software instructions for a browser application to enable the connectivity and display of data during a conference session, etc.). The device also includes a network interface unit (e.g., one or more network interface card or switches) 230 to communicate with other devices over one or more networks. Meeting server 110, such as an all-in-one on-premise meeting server, may additionally comprise telephone service logic 240, desktop sharing service logic 242, web service sharing logic 244, audio service logic 246, and video service logic 248. The functional blocks 240-248 of meeting server 110 may be embodied by dedicated or combined application specific integrated circuits (ASICs) containing digital logic. Alternatively, one or more of the functional blocks 240-248 may be embodied by software stored in memory 220 and executed by processor 210.

Memory 220 may comprise read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes described herein. Thus, in general, the memory 220 may comprise one or more tangible (non-transitory) computer readable storage media (e.g., a memory device) encoded with software comprising computer executable instructions and when the software is executed (by the processor 220) it is operable to perform the operations described herein.

In one example, meeting server 110 uses the default gateway address to assign a proxy client to a new client device joining the online conference session. This allows the new client to receive the conference session data from a proxy client that is on the same Local Area Network (LAN), avoiding excessive network traffic. One example of a system to locate a proxy client in the same LAN as a new client device is described hereinafter.

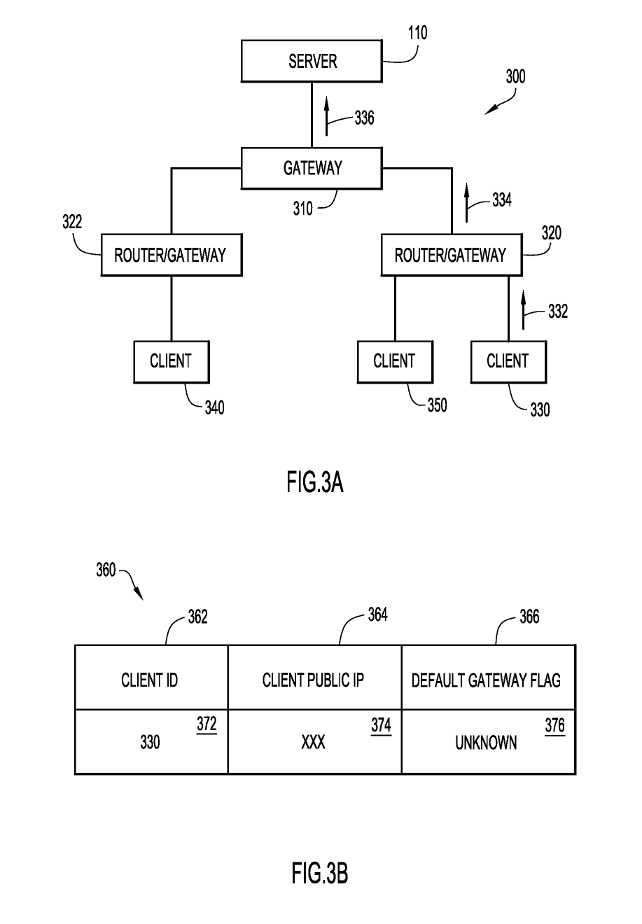

Referring now to FIG. 3A, a simplified block diagram of the network setup for a client joining the online conference session is shown. Meeting server 110 couples to gateway 310 in order to communicate with gateway/routers 320 and 322. Client devices 330, 340, and 350 communicate to the meeting server 110 through the gateway/routers 320 or 322. In this example, client devices 330 and 350 are coupled to gateway/router 320 and client device 340 is coupled to gateway/router 322. When client 330 joins the online conference session, it sends message 332 to gateway/router 320. Gateway/router 320 forwards the request 334 to gateway 310, and gateway 310 passes the request 336 to meeting server 110. In one example, meeting server 110 records selected details of client 330 to facilitate the online conference session.

FIG. 3B shows an example of a table of client devices that have joined the online conference session. In this example, table 360 includes client ID column 362, public Internet Protocol (IP) address column 364, and default gateway flag column 366. When client device 330 requests to join the online conference session, table 360 is populated with information from client device 330. In this example, the meeting server 110 populates client ID value 372 with “330,” public IP address 374 with a value of “XXX,” and default gateway flag value 376 with “unknown.”

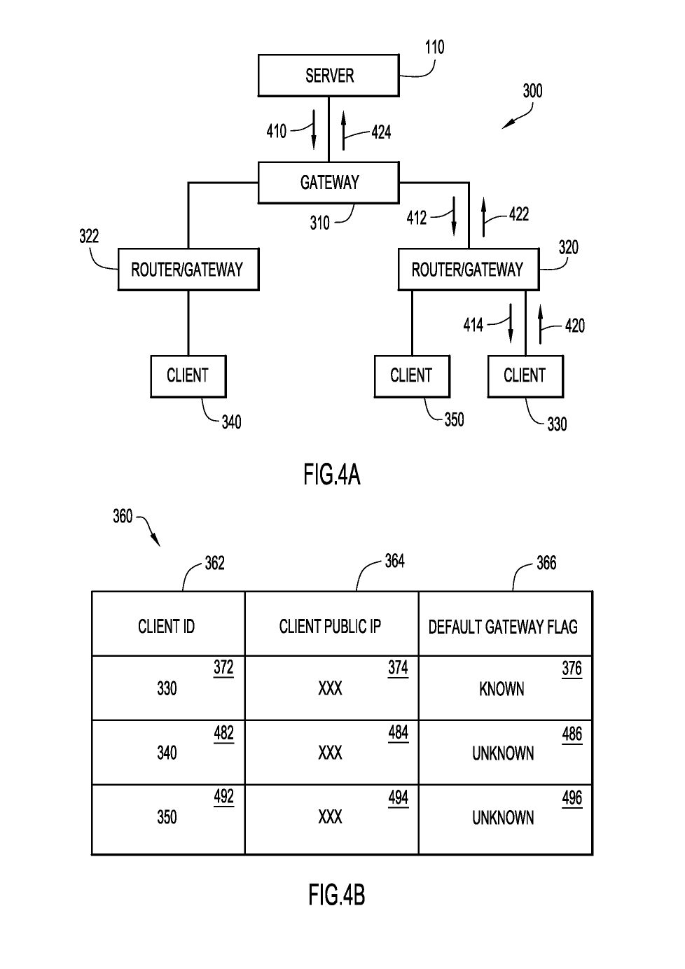

Referring now to FIG. 4A, a simplified block diagram is shown that is similar to FIG. 3A, in which meeting server 110 queries client device 330 for its default gateway address. After client device 330 registers with the meeting server 110, the meeting server 110 sends a request 410 for the default gateway address of client 330. The request 410 goes to gateway 310, which forwards the request 412 to gateway/router 320. Gateway/router 320 forwards the request 414 to client 330. Client 330 responds by sending message 420, which includes its default gateway address, to gateway/router 320. Gateway/router 320 forwards the message 422 to gateway 310, which in turn forwards the message 424 to the meeting server 110. In another example, gateway/router 320 is aware of the default gateway for client 330 and responds to request 412 with message 422 without forwarding the request 414 to client 330 and waiting for message 420.

FIG. 4B shows another example of table 360 listing client devices that have joined the online conference session, similar to the table described with reference to FIG. 3B. In this example, client devices 340 and 350 have joined the online conference session, and have entries in table 360. For client device 340, meeting server 110 populates client ID value 482 with “340,” public IP address 484 with “XXX,” and default gateway flag value 486 with “unknown.” Similarly, client ID value 492 has a value of “350,” public IP address 494 has a value of “XXX,” and default gateway flag value 496 has a value of “unknown.” In this example, moreover, all of the client devices 330, 340, and 350 have the same public IP address, and the default gateway address is used to determine which client devices are close to each other in the network infrastructure. By the requests 410-414 and the response messages 420-424, meeting server 110 learns the default gateway address for client device 330, and changes the default gateway flag value 376 to “known.”

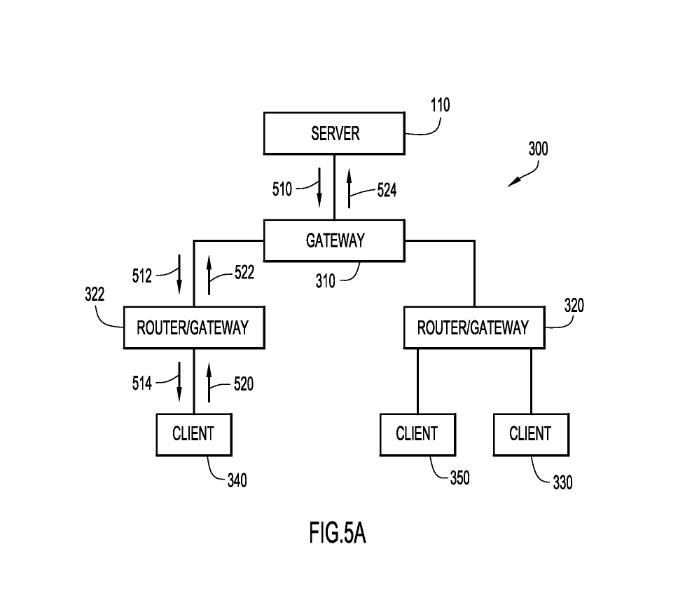

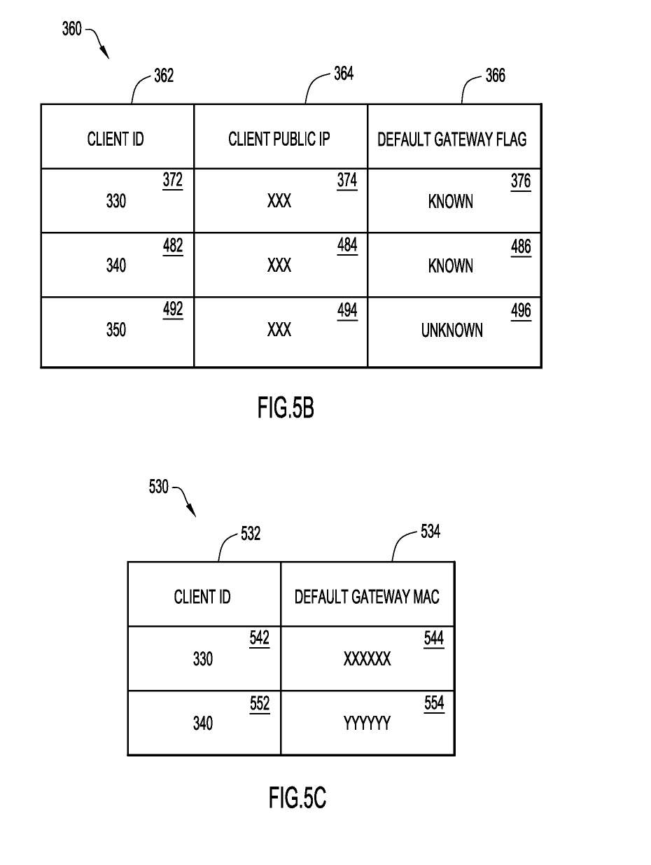

Referring now to FIG. 5A, a simplified block diagram, similar to FIGS. 3A and 4A, of meeting server 110 querying client device 340 for its default gateway address is shown. After client device 340 registers with the meeting server 110, the meeting server 110 sends a request 510 for the default gateway address of client 340. The request 510 goes to gateway 310, which forwards the request 512 to gateway/router 322. Gateway/router 322 forwards the request 514 to client 340. Client 340 responds by sending message 520 including its default gateway address to gateway/router 322. Gateway/router 322 forwards the message 522 to gateway 310, which in turn forwards the message 524 to the meeting server 110. In another example, gateway/router 322 is aware of the default gateway for client 340 and responds to request 512 with message 522 without forwarding the request 514 to client 340 and waiting for message 520.

Reference is now made to FIG. 5B, which shows another example of the table 360 listing client devices that have joined the online conference session, similar to the table described with reference to FIGS. 3B and 4B. In this example, meeting server has requested the default gateway address of client device 340, and updates default gateway address flag 486 to a value of “known.”

Reference is now made to FIG. 5C, which shows an example of a table of default gateway addresses for the client devices that have known default gateway addresses. In this example, table 530 includes client ID column 532 and default gateway address column 534. When meeting server 110 has received messages 424 and 524 with the default gateway addresses of clients 330 and 340, respectively, the meeting server 110 populates client ID value 542 with “330,” default gateway address value 544 with “XXXXXX,” client ID value 552 with “340,” and default gateway address value 554 with “YYYYYY.” In this example, clients 330 and 340 are on different subnets, and have different default gateway addresses.

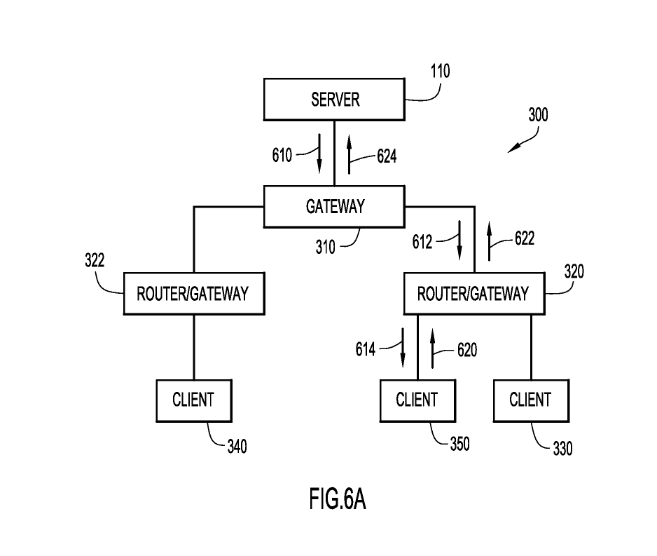

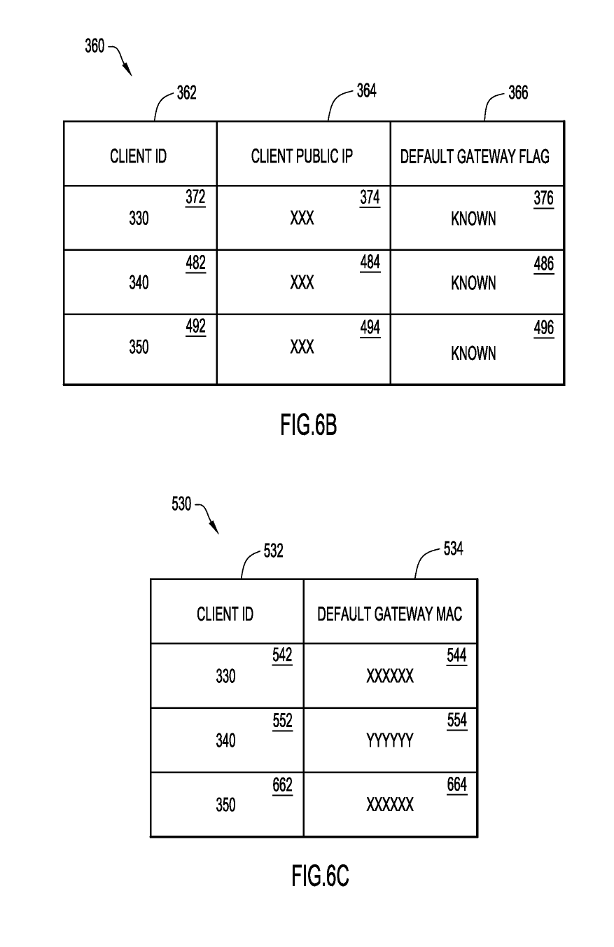

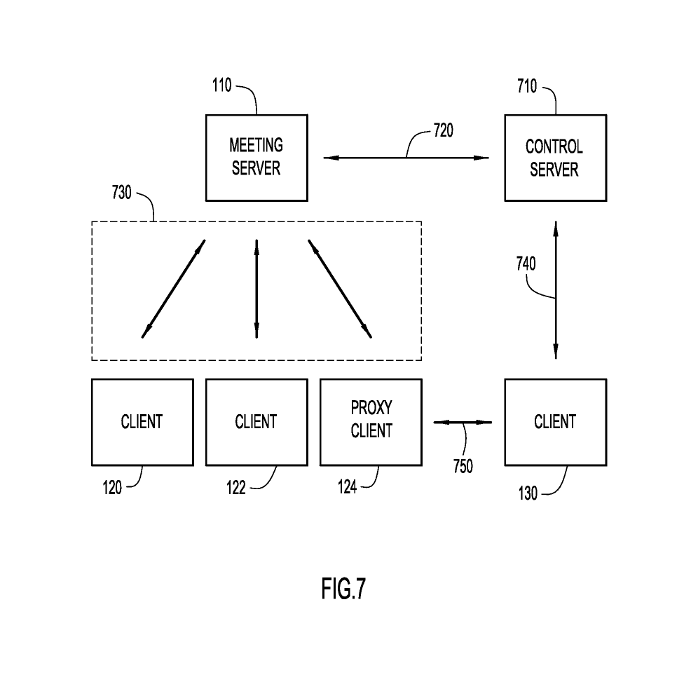

Referring now to FIG. 6A, a simplified block diagram is shown, that is similar to FIGS. 3A, 4A, and 5A. In this diagram, meeting server 110 queries client device 350 for its default gateway address. After client device 350 registers with the meeting server 110, the meeting server 110 sends a request 610 for the default gateway address of client 350. The request 610 goes to gateway 310, which forwards the request 612 to gateway/router 320. Gateway/router 320 forwards the request 614 to client 350. Client 350 responds by sending message 620 including its default gateway address to gateway/router 320. Gateway/router 320 forwards the message 622 to gateway 310, which in turn forwards the message 624 to the meeting server 110. In another example, gateway/router 320 is aware of the default gateway for client 350 and responds to request 612 with message 622 without forwarding the request 614 to client 350 and waiting for message 620.

Reference is now made to FIG. 6B, which shows another example of the table 360 of client devices that have joined the online conference session, similar to the table described with reference to FIGS. 3B, 4B, and 5B. In this example, meeting server has requested the default gateway address of client device 350, and updates default gateway address flag 496 to a value of “known.”

Reference is now made to FIG. 6C, showing a table of default gateway addresses for the client devices that have known default gateway addresses. When meeting server 110 has received message 624 with the default gateway addresses of client 350, the meeting server 110 populates client ID value 662 with “350,” and default gateway address value 664 with “XXXXXX.” In this example, clients 330 and 350 are on the same subnet, and have the same default gateway address.

Referring now to FIG. 7, a block diagram that separates some of the functions of the meeting server into a control server is shown. In one example, meeting server 110 and control server 710 share responsibility over connection 720 for facilitating the online conference session. In this example, client devices 120, 122, and 124 communicate directly with meeting server 110 over the connections 730. When new client device 130 attempts to join the online conference session, it communicates with control server 710 over connection 740. In this example, the meeting server 110 does not have the resources to support a connection with client device 130, and control server 710 directs client device 130 to join the conference session through proxy client 124 over connection 750.

In another example, client device 130 may request a list of potential proxy clients for a particular conference session from control server 710. Control server 710 may provide client device 130 with a list of some or all of the client devices participating in the conference session that are able to act as proxy clients. Once it receives the list of proxy clients, client device 130 may send the request to join the conference session directly to proxy client 124.

In one example, the list of potential proxy clients may be returned to client device 130 via an Extensible Markup Language (XML) Application Programming Interface (API). Control server 710 may request a list of participants by using the conference session identifier. Meeting server 110 responds with a list of the addresses of the participating client devices, which the control server 710 uses to generate the XML list of potential proxy clients.

In yet another example, meeting server 110 and control server are separate devices that may or may not be co-located. Alternatively, meeting server 110 and control server may be a single physical server with separate services for communicating the data from the conference session and the data to manage the conference session. The service for communicating the data from the conference session may have a connection limit imposed by the server resources, while the service for managing the conference session may have a higher connection limit, or no limit, to allow additional client devices to contact the server and join the conference session through a proxy client.

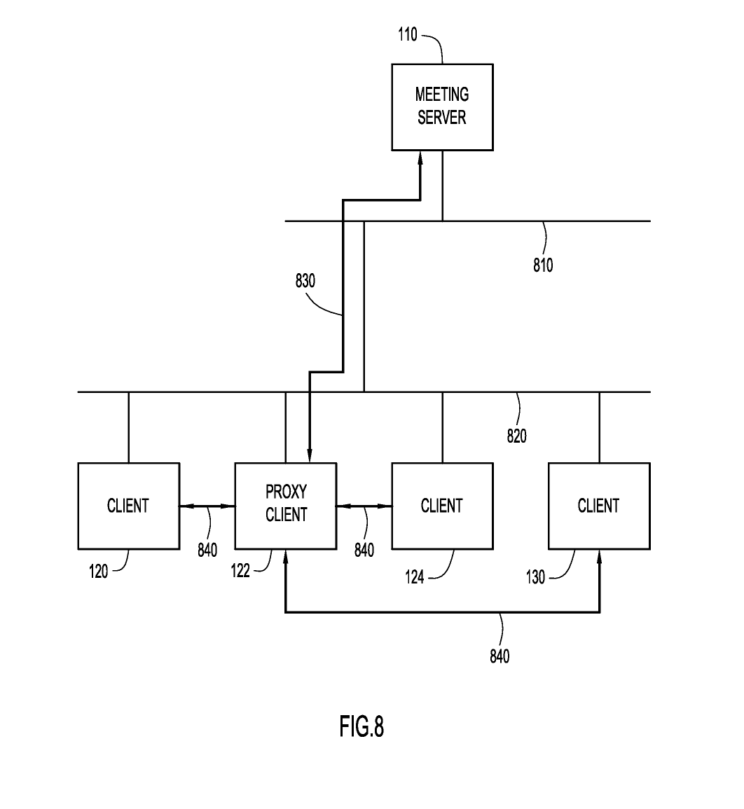

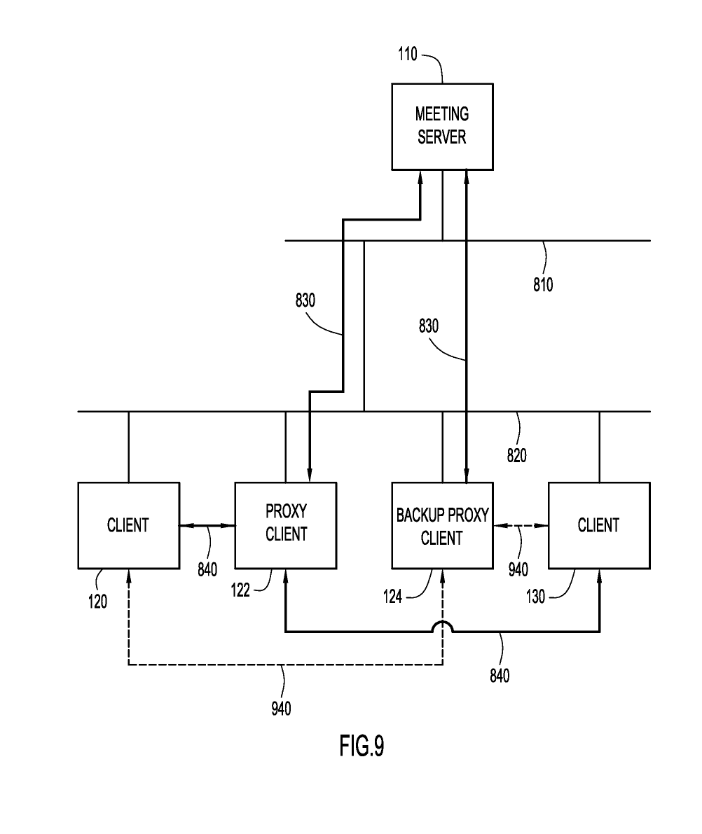

Referring now to FIG. 8, a block diagram of an online conference session using a proxy client to maximize network bandwidth is shown. In one example, meeting server 110 connects to a relatively low bandwidth network 810, while client devices 120, 122, 124, and 130 all connect to a relatively high bandwidth network 820. Meeting server 110 designates client device 122 as the proxy client and communicates all of the data for the participants on network 820 through client device 122 over connection 830. The other client devices 120, 124, and 130 that are on network 820 participate in the online conference over connections 840. While only one network 820 is shown in FIG. 8, other LANs may be connected to network 810 and may use a similar configuration. For example, a meeting server based in Denver may facilitate a conference session that includes a plurality of client devices on a LAN in San Jose as well as a plurality of client devices on a LAN in New York.

Referring now to FIG. 9, a block diagram shows another example of an online conference session using proxy clients. The network configuration is similar to FIG. 8, with meeting server 110 on network 810 and the client devices on LAN 820, and client device 122 acting as a proxy for client devices 120 and 130 over connections 840. In this example, client device 124 communicates directly with meeting server 110, and is designated as a backup proxy client that is able to serve as a proxy client for client devices 120 and 130 over connections 940. In other words, client devices 120 and 130 have an address for a second proxy client 124, which they would connect to in the event that the primary proxy client 122 becomes unavailable.

While only one primary proxy and one backup proxy have been shown in FIG. 9, a pool of multiple backup proxies may be designated, each able to serve as a proxy client for other client devices. In one example, a list of addresses is created corresponding to client devices that are able to act as a proxy client. The list of addresses may be ordered, such that the primary proxy is at the top of the list, with the first backup proxy second on the list, and the second backup proxy third on the list, and so on. Alternatively, the list of addresses may not be ordered, and each client device determines an appropriate address when there is a need for a proxy client. The list of addresses may be sent to each of the client devices in the conference session.

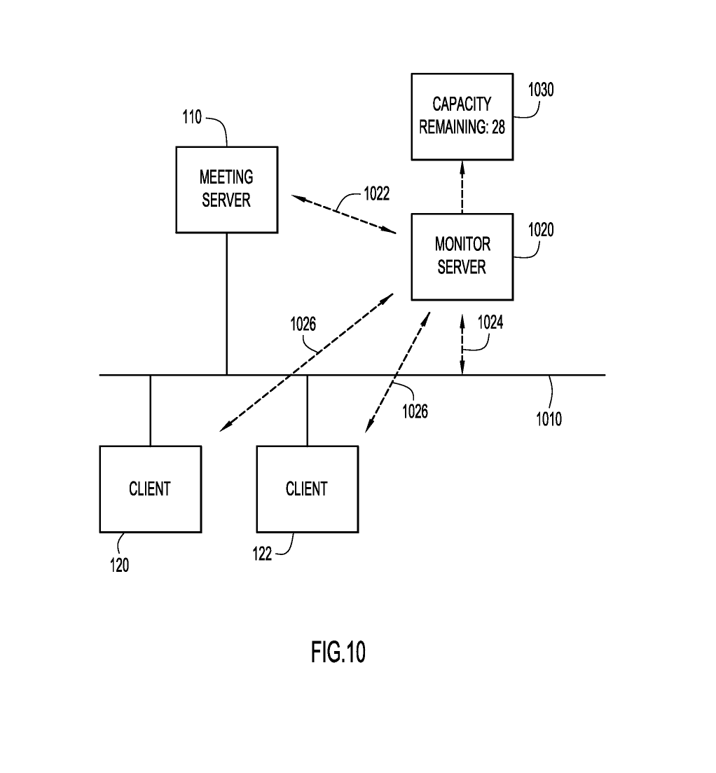

Referring now to FIG. 10, a block diagram shows another example of a separate server helping to facilitate an online conference session. In this example, meeting server 110 communicates the data associated with the online conference session between client devices 120 and 122 over network 1010. Monitor server 1020 communicates with meeting server over connection 1022 to determine the capabilities (e.g., number, type, and speed of processing cores, amount of memory, etc.) of the meeting server 110. Monitor server 1020 also monitors the characteristics of network 1010 over connection 1024 to determine, e.g., network speed, bandwidth, and/or reliability. Monitor server 1020 further communicates with client devices 120 and 122 over connection 1026 to monitor their capabilities. In compiling all of the data on the capabilities of the hardware involved in conference session, monitor server 1020 is able to accurately determine, in real-time, the capacity 1030 remaining in the conference session. The remaining capacity 1030 may be communicated to the meeting server 110 or a control server to provide an indication of whether a new client device should join the conference session by directly connecting to the meeting server or by connecting via a proxy client.

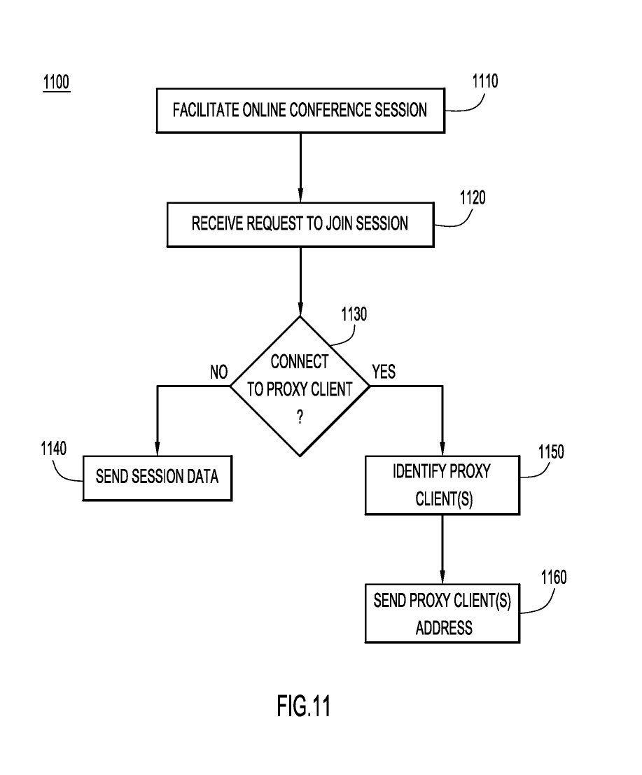

Referring now to FIG. 11, a flowchart for an example process 1100 for a meeting server according to the techniques presented herein is shown. In this example, the meeting server is facilitating an online conference session between a plurality of client devices at step 1110. In step 1120, the meeting server receives a request to join the conference session from a new client device. If the meeting server does not want or need to use a proxy client, as determined in step 1130, then the meeting server begins sending the data from the conference session to the new client device at step 1140. If the meeting server is going to use a proxy client (e.g., the meeting server has reached its maximum number of connections), then the meeting server identifies at least one client device that is capable of acting as a proxy client at step 1150. The proxy client may be selected at random, or an algorithm may be used to determine the best proxy client for a new client device. The algorithm may account for network conditions (e.g., bandwidth, wired/wireless, etc.), device type (e.g., desktop, laptop, mobile device), device hardware (e.g., processor, memory), and/or proxy connection number. In step 1160, the meeting server 110 sends the address for at least one proxy client that the new client device can use to join the conference session.

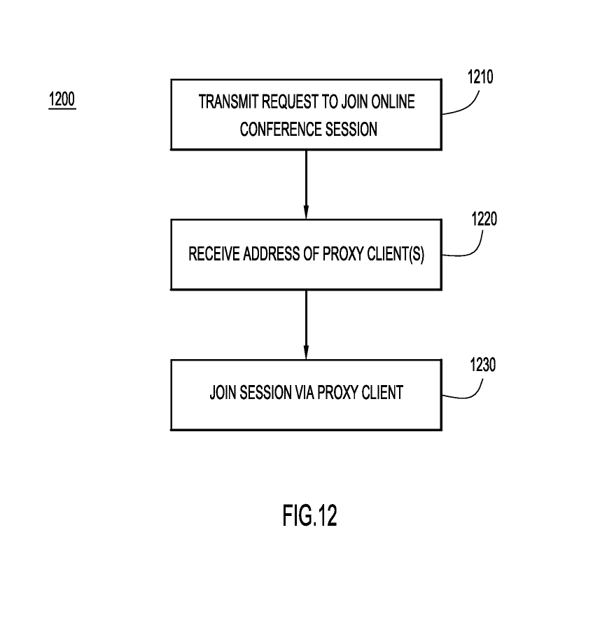

Referring now to FIG. 12, a flowchart for an example process 1200 for a client device to join an online conference session according to the techniques presented herein. In step 1210, a new client device transmits a request to join an online conference session. The request may be sent to the meeting server facilitating the entire conference session, or it may be sent to a control server that facilitates the setup of the conference session. In step 1220, the new client device receives a response with the address of at least one proxy client. The new client device joins the conference session via the proxy client at step 1230.

In summary, the techniques presented herein allow an online meeting system to dynamically switch the route for a new client device to join a meeting. This allows a system with constrained resources, such as on-premise meeting systems, to allow more participants to join a full meeting. For meetings that are not full, i.e., the meeting server has enough resources to accommodate additional clients, the techniques presented herein are not automatically triggered, since they may not be necessary. While the following description may be used with an on-premise meeting system, the techniques may also be applicable to a cloud based meeting system. Additionally, to maintain the security of a meeting, only devices that are already participating in a meeting will be selected as proxy clients for that particular meeting. In this way, meeting data is prevented from being routed through a third party, where it may be subject to eavesdropping.

Further, the techniques presented herein enable a method that facilitates an online conference session between a plurality of endpoints, the plurality of endpoints connecting to a meeting server. The meeting server receives a request to join the online conference session from a first endpoint of the plurality of endpoints and identifies at least one endpoint from the plurality of endpoints already connected to the meeting server that can serve as a proxy endpoint for the first endpoint. The first endpoint can then receive data from the online conference session through a connection with the proxy endpoint.

A first endpoint may transmit a request to join an online conference session that involves a plurality of endpoints. The first endpoint receives an address of at least one proxy endpoint selected from the plurality of endpoint devices that is to serve as a proxy endpoint for the first endpoint. By connecting to the proxy endpoint, the first endpoint joins the online conference session and receives data from the online conference session from a meeting server via the proxy endpoint.

Additionally, a meeting server may comprise a network interface configured to communicate data from an online conference session between the meeting server and a plurality of endpoint devices. The meeting server may further comprise a processor configured to receive a request to join the online conference session from a first endpoint. The processor may additionally be configured to identify at least one endpoint from the plurality of endpoints already connected to the meeting server that can serve as a proxy endpoint for the first endpoint. This enables the first endpoint to receive data from the online conference session through a connection with the proxy endpoint.

The above description is intended by way of example only. Various modifications and structural changes may be made therein without departing from the scope of the concepts described herein and within the scope and range of equivalents of the claims.

What is claimed is:

1. A method comprising:
facilitating an online conference session between a plurality of endpoints, the plurality of endpoints connecting to a meeting server;
receiving, at the meeting server, a request to join the online conference session from a first endpoint that is not part of the plurality of endpoints;
identifying at least one endpoint from the plurality of endpoints that can serve as a proxy endpoint for the first endpoint; and
enabling the first endpoint to receive data from the online conference session through a connection with the proxy endpoint.

2. The method of claim 1, wherein the online conference session comprises up to a predetermined maximum number of connections between the meeting server and the plurality of endpoints.

3. The method of claim 2, further comprising determining whether connecting the first endpoint to the meeting server would exceed the predetermined maximum number of connections, and wherein the at least one endpoint is identified to serve as the proxy endpoint in response to the determination.

4. The method of claim 1, further comprising transmitting an address of the proxy endpoint to the first endpoint.

5. The method of claim 1, wherein identifying the at least one proxy endpoint comprises comparing a gateway address of the first endpoint to saved gateway addresses associated with each of the plurality of endpoints, the saved gateway addresses corresponding to gateway devices that serve as intermediaries between endpoints and the meeting server, and selecting the at least one proxy endpoint having the same gateway address as the first endpoint.

6. The method of claim 1, wherein identifying the at least one proxy endpoint comprises selecting the proxy endpoint based on an indication of resources available at each of the plurality of endpoints in order to serve as a proxy.

7. The method of claim 1, further comprising receiving data for the online conference session from the first endpoint through the proxy endpoint.

8. A method comprising:
transmitting from a first endpoint a request to join an online conference session that involves a plurality of endpoints other than the first endpoint;
receiving an address of at least one proxy endpoint selected from the plurality of endpoint devices that is to serve as a proxy endpoint for the first endpoint; and
the first endpoint joining the online conference session by connecting to the proxy endpoint and receiving data from the online conference session from a meeting server via the proxy endpoint.

9. The method of claim 8, further comprising receiving, at the first endpoint device, an indication that connecting the first endpoint device to the meeting server would exceed a predetermined number of connections between the endpoint devices and the meeting server.

10. The method of claim 8, wherein receiving the address of at least one proxy endpoint comprises receiving an address of a primary proxy endpoint and receiving an address of a backup proxy endpoint.

11. The method of claim 10, wherein joining the online conference session comprises connecting to the primary proxy endpoint, and further comprising, if it is determined that the primary proxy endpoint is unavailable or unable to serve as a proxy, connecting to the backup proxy.

12. The method of claim 8, wherein transmitting the request to join the online conference session comprising transmitting, to a control server different from the meeting server, a request to join the online conference session.

13. The method of claim 12, further comprising receiving an indication that connecting to the meeting server would exceed a predetermined maximum number of connections from the control server, and receiving the address of at least one proxy endpoint device from the control server.

14. The method of claim 8, wherein joining the online conference session comprises connecting to a proxy endpoint that has a common gateway with the first endpoint.

15. An apparatus comprising:
a network interface configured to communicate data from an online conference session between a meeting server and a plurality of endpoint devices;
a processor configured to:
receive a request to join the online conference session from a first endpoint that is not part of the plurality of endpoints;
identify at least one endpoint from the plurality of endpoints that can serve as a proxy endpoint for the first endpoint; and
enable the first endpoint to receive data from the online conference session through a connection with the proxy endpoint.

16. The apparatus of claim 15, wherein the online conference session comprises up to a predetermined maximum number of connections between the meeting server and the plurality of endpoints.

17. The apparatus of claim 16, wherein the processor is further configured to determine whether connecting the first endpoint to the meeting server would exceed the predetermined maximum number of connections, and wherein the at least one endpoint is identified to serve as the proxy endpoint in response to the determination.

18. The apparatus of claim 15, wherein the processor is further configured to transmit an address of the at least one proxy endpoint to the first endpoint.

19. The apparatus of claim 15, wherein the processor is further configured to identify the at least one proxy endpoint device by comparing a gateway address of the first endpoint device to saved gateway addresses associated with each of the plurality of endpoints, the saved gateway addresses corresponding to gateway devices that serve as intermediaries between endpoints and the meeting server, and select the at least one proxy endpoint having the same gateway address as the first endpoint device.

20. The apparatus of claim 15, wherein the processor is further configured to identify the at least one proxy endpoint by selecting the proxy endpoint based on an indication of the resources available at each of the plurality of endpoints in order to serve as a proxy.

21. The apparatus of claim 15, wherein the processor is further configured to receive data for the online conference session from the first endpoint through the proxy endpoint.
